(19) United States
(12) Patent Application Publication
(10) Pub. No.: US 2013/0112458 A1
(43) Pub. Date: May 9, 2013

(54) DEVICE FOR PROTECTION OF A LIVE ELEMENT MOUNTED ON A SUPPORT IN AN ELECTRICAL BOX

(71) Applicant: Frédéric Alain Gautier, Gagny (FR)

(72) Inventor: Frédéric Alain Gautier, Gagny (FR)

(21) Appl. No.: 13/490,965

(22) Filed: Jun. 7, 2012

(30) Foreign Application Priority Data
Jun. 8, 2011 (FR) FR 1155016

(51) Int. Cl. H01B 17/38

(52) U.S. Cl. CPC H01B 17/38
USPC 174/188; 29/592.1

(57) ABSTRACT

Device for protection of a live element mounted on a support in an electrical distribution box, comprising an insulative cap adapted to cover the live element and retaining means adapted to retain the protection device fixed to the support. The protection device comprises an articulated junction adapted to couple the cap to the retaining means so that the cap is articulated relative to the retaining means in a first position in which the live element is electrically protected and a second position enabling access to the live element.

### BACKGROUND OF THE INVENTION

1. Field of the Invention

The invention concerns the protection of live parts in an electrical box, and more particularly the protection of the systems for fixing a distribution bar in an electrical distribution box.

2. Description of the Relevant Art

The distribution of electrical energy, for example in an aircraft, is generally effected with the aid of electrical distribution boxes relaying by means of cables energy produced by electrical generators driven by engines. An electrical distribution box may then route the received electrical energy to loads or other electrical distribution boxes.

Each electrical distribution box includes distribution components some of which have the function of switching the received electrical energy to a distribution bar contained in the same electrical distribution box or in another electrical distribution box.

A distribution bar is a conductive bar to which are coupled, on the one hand, a source of electrical energy and, on the other hand, various electrical units to which the electrical energy received by the distribution bar is distributed. The source of electrical energy may be a generator in the case of a distribution bar of a primary electrical distribution box or a primary electrical distribution box in the case of a distribution bar of a secondary electrical distribution box. These electrical units to which the electrical energy received by the distribution bar is distributed may be secondary distribution sub-networks or electrical loads.

Being conductive and coupled at all times to sources of electrical energy, these distribution bars must be protected from surrounding objects, and more particularly from metal bodies liable to move freely inside the distribution box and able to come into contact with the distribution bar and disturb the electrical circulation and even lead to an accidental short circuit between a distribution bar and another bar or ground, for example. For example, electrically conductive elements fixed to the box are liable to become detached because of vibrations generated in flight, drop to the bottom of the box and come into contact with the distribution bars.

To this end, the distribution bars are generally protected by an insulative protection covering the surface of the distribution bar.

Moreover, the distribution bars are fixed inside the electrical distribution boxes to connect in terminals with the aid of a screw, for example. These fixing means, such as screws or nuts, are generally conductive and must also be electrically insulated given that they are in direct contact with the distribution bars.

To provide electrical protection for these live fixing means, it is known to insulate the conductive parts by evaporating an insulator such as varnish onto the visible parts of the fixing means. However, such a system has the major drawback that once the varnish has been evaporated maintenance is more difficult given that the parts must be cleaned before reassembly and that the insulation may creep into areas through which current passes, leading to overheating.

It is also known to use insulative protective washers between the screw, or the nut, and the distribution bar. However, the protection offered by such a protection device is only partial, given that live areas are still accessible. The screw may remain in contact with the inside of the distribution bar and consequently always be live.

Also known is the use of a cap mounted on the fixing means. For example, an insulative cap may be fixed over the head of a screw coupling the distribution bar to a terminal. However, such a device does not enable the tightness of the fixing means to be verified, since once fitted the cap offers no means of access to the clamping means.

### SUMMARY OF THE INVENTION

The invention aims to solve the problems referred to above by proposing a device for protection of a live element mounted on a support adapted to protect the live element from any contact with another element whilst preserving access to the live element to enable maintenance operations.

In one aspect, there is proposed, in one embodiment, a device for protection of a live element mounted on a support in an electrical distribution box, comprising an insulative cap adapted to cover the live element and retaining means adapted to retain the protection device fixed to the support.

According to one general feature, the protection device comprises an articulated junction adapted to articulate the cap relative to the retaining means in a first position in which the live element is electrically protected and a second position enabling access to the live element.

The articulated junction thus enables the provision of a cap covering the live element and protecting it from any contact with the surrounding elements and enables access to the live element in order to monitor its state or to perform maintenance operations.

The cap, the retaining means and the articulated junction may advantageously be made in one piece, for example a plastic part. This facilitates fitting the protection device and protection is improved since the articulation may be produced in plastic material, which has intrinsic elasticity, instead of using a conductive metal spring.

The cap may advantageously have dimensions enabling protection of at least one additional live element mounted on the support.

The protection device may thus be produced with dimensions enabling protection of all live elements mounted on the same bar with only one insulative cap. The shape of the cap may also be adapted to the shape of a live element.

The retaining means preferably comprise fixing elements in the support adapted to adapt as a function of the thickness of the support.

Such a fixing element may for example comprise two rods projecting outward from the retaining means, each of the two rods comprising at least one abutment lug at its free end adapted to cooperate with the distribution bar when the rods are inserted in an orifice produced within the thickness of the distribution bar so as to retain the protection device coupled to the distribution bar.

The retaining means may advantageously comprise notches enabling access to the fixing elements for removing the device.

These notches produced in the retaining means of the protection device may, for example, enable access by an instrument such as pliers for disengaging the fixing elements from the orifices in the support or for applying the force necessary for extraction. If two fixing rods are used, the abutment lugs may be disengaged in such a manner as to enter the orifice and thus decouple the protection device from the distribution bar.

In one embodiment, the support comprises a conductive bar, or distribution bar, of the electrical distribution box and the live element comprises means, such as a crew, for fixing said conductive bar to an electrical connecting terminal, the conductive bar being covered by an electrical insulator except in the electrical connection areas.

In another aspect, there is proposed, in one embodiment, a method of protecting a live element mounted on a support in an electrical distribution box, wherein the live element is covered with an insulative cap, the cap being articulated and having a first position in which the live element is electrically protected and a second position enabling access to the live element.

The cap, the retaining means and an articulated junction may advantageously be made in one piece, the articulated junction enabling articulation of the cap relative to the retaining means.

The cap may also be dimensioned to cover at least one supplementary live element mounted on the support.

The retaining elements are preferably fixed to the support with the aid of fixing elements adaptable to the thickness of the support.

The retaining means may advantageously be removed by accessing the fixing elements via notches produced in the retaining means.

### BRIEF DESCRIPTION OF THE DRAWINGS

Other advantages and features of the invention will become apparent on examining the detailed description of different nonlimiting embodiments of the invention and the appended drawings, in which:

FIG. 1 represents a view in section of a device for protection of a live element of one embodiment;

FIG. 2 provides a top view of the protection device shown in FIG. 1.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

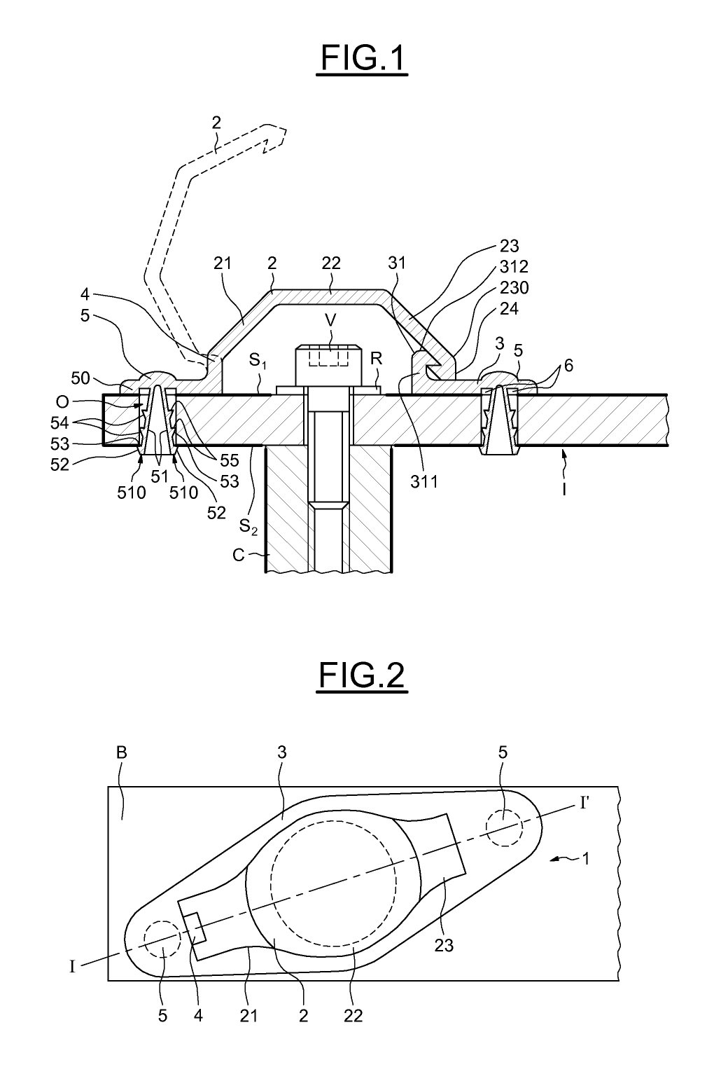

In FIG. 1 there is represented a view in section taken along the line I-I′ of a device 1 for protecting a screw V fixing an electrical distribution bar B to a connecting terminal C in one embodiment of the invention.

The distribution bar B, contained in an electrical distribution box, is produced in an electrically conductive material such as metal and is covered with an insulative protection layer I such as varnish or vinyl. The distribution bar B is mechanically and electrically coupled to the connecting terminal C via a fixing screw V. This connecting terminal C is electrically connected to a load or to another distribution box or even to a source of electrical energy such as an electrical generator. The head of the fixing screw V is separated from the distribution bar B by a washer R. This washer may be in a conductive or insulative material.

The protection device 1 comprises an insulative material cap 2, retaining means 3 and an articulation 4 enabling articulation of the cap 2 relative to the retaining means 3. In this embodiment, the cap 2, the retaining means 3 and the articulation 4 are produced in one piece in a plastic material.

The articulation 4 enables movement of the cap 2 from a position protecting the screw V to an open position in which a user can access the screw V to inspect visually the state of the screw V, to check its tightness and/or to carry out maintenance.

In the sectional view, the cap 2 has three sections, namely a proximal section 21 coupled to the articulation 4, a median section 22 intended to overlie the head of the screw V when the cap 2 is in the protection position, and a distal section 23. The median section 22 separates the distal section 23 from the proximal part 21.

When the cap 2 is in the protection position, the median section 22 is parallel to the distribution bar B while the proximal section 21 is inclined to provide the connection between the articulation 4 and the median section 22. The distal section is inclined to the proximal section 21 in anti-parallel manner. Thus the screw V is entirely covered by the cap 2.

The distal section 23 comprises at its free end 230, namely the end opposite the end coupled to the median section 22, a clipping element 24 having a portion bent back toward the median section 22. The clipping element 24 cooperates with a complementary clipping element 31 to retain the cap 2 in the protection position. The complementary clipping element 31 has a projecting portion 311 extending upward at the end of which a portion 312 bent back toward the distribution bar B forms a hook.

As shown in FIGS. 1 and 2, the retaining means 3 comprise fixing elements 5 enabling fixing of the protection device 1 to the distribution bar B. In this example, two fixing elements 5 are disposed on the retaining means 3 in diametrically opposite positions relative to the center of the protection device 1 to assure a better fixing.

Each fixing element 5 has a base 50 and two projecting portions 51 extending downward from the base 50. These projecting portions 51 are divergent and become farther away from each other as they become farther from the base 50. Each projecting portion 51 has at its free end 510 a fixing lug 52 forming a shoulder 53 facing the base 50. Thus when a fixing element 5 is inserted in an orifice O in the distribution bar B the two projecting portions 51 are forced toward each other so as to be able to be inserted in the orifice O and pushed in until the base 50 is in contact with the upper surface SO of the distribution bar B. The lugs 52 have then passed entirely through the orifice. The projecting portions 51 move away from each other, the stress being reduced, bringing the shoulder 53 of each lug 52 against the lower surface S2 of the distribution bar B.

Each projecting portion 51 also comprises supplementary lugs 54 regularly disposed between the free end 510 on which the lug 52 is located and the base 50. Each supplementary lug 54 includes a shoulder 55 facing the base 50. The supplementary lugs 54 enable fixing of the protection device 1 to distribution bars B or to other elements thinner than the lug 52 disposed at the free ends 510 of the projecting portions 51.

The fixing elements 5 as shown in these figures thus enable the device to be retained in place in the three directions in space.

In the embodiment shown in FIG. 1, the retaining means 3 further comprise notches 6. To this end, the thickness of the base 50 of the fixing elements 5 has been increased and notches have been produced on each side of the fixing element to provide access to the projecting portions 51. It is thus possible to insert pliers, for example, into these notches to apply a force to each of the projecting portions 51 tending to move them toward each other. In this way the lugs 52 or the supplementary lugs 54 may be disengaged from the lower surface SO and the fixing element 1 may be extracted from the orifice O.

The invention proposes a device for protection of a live element mounted on a support adapted to protect the live element from any contact with another element and to provide access to the live element in the event of maintenance.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. Device for protection of a live element mounted on a support in an electrical distribution box, comprising:
an insulative cap adapted to cover the live element;
retaining means adapted to retain the protection device fixed to the support; and
an articulated junction adapted to articulate the cap relative to the retaining means in a first position in which the live element is electrically protected and a second position enabling access to the live element.

2. Device according to claim 1, wherein the cap, the retaining means and the articulated junction are produced in one piece.

3. Device according to claim 1, wherein the cap has dimensions enabling protection of at least one supplementary live element mounted on the support.

4. Device according to claim 1, wherein the retaining means comprise fixing elements in the support adapted to adapt as a function of the thickness of the support.

5. Device according to claim 4, wherein the retaining means comprise notches enabling access to the fixing elements for removing the device.

6. Device according to claim 1, wherein the support comprises a conductive bar of the electrical distribution box and the live element comprises means for fixing said conductive bar to an electrical connecting terminal, the conductive bar being covered by an electrical insulator.

7. Method of protecting a live element mounted on a support in an electrical distribution box, wherein the live element is covered with a device comprising an insulative cap, the cap being articulated, wherein the method comprises
articulating the cap into a first position in which the live element is electrically protected and
articulating the cap into a second position enabling access to the live element.

8. Method according to claim 7, wherein the device comprises, a retaining means and an articulated junction, wherein the cap, the retaining means and the articulated junction are made in one piece, the articulated junction enabling articulation of the cap relative to the retaining means.

9. Method according to claim 7, wherein the cap is dimensioned to cover at least one supplementary live element mounted on the support.

10. Method according to claim 8, wherein the retaining means are fixed to the support with the aid of fixing elements adaptable to the thickness of the support.

11. Method according to claim 10, wherein the retaining means are removed by accessing the fixing elements via notches produced in the retaining means.
